(19) United States
(12) Patent Application Publication
(10) Pub. No.: US 2003/0226710 A1
(43) Pub. Date: Dec. 11, 2003

(54) Electric power steering apparatus

(75) Inventors: Yusuke Itakura, Maebashi-Shi (JP); Hideaki Kawada, Maebashi-Shi (JP); Kazuhiro Kumaido, Maebashi-Shi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: NSK LTD.

(21) Appl. No.: 10/408,252

(22) Filed: Apr. 8, 2003

Related U.S. Application Data
(62) Division of application No. 09/982,862, filed on Oct. 22, 2001.

(30) Foreign Application Priority Data
Oct. 20, 2000 (JP) 2000-321181
Oct. 20, 2000 (JP) 2000-321182

(51) Int. Cl. B62D 5/04

(52) U.S. Cl. 180/443

(57) ABSTRACT

In an electric power steering apparatus provided with a steering state detecting means for detecting a steering state of a steering system, a motor control signal generating means for determining and outputting a motor control signal on the basis of a steering state detecting signal outputted from the steering state detecting means, a motor driving means for driving a motor on the basis of a motor control signal outputted from the motor control signal generating means, and a motor control signal monitoring means for monitoring the motor control signal generating means on the basis of the signals outputted from the steering state detecting means and the motor driving means, there are provided with an operation stop detecting means for detecting an operation stop command of the motor control signal generating means, and a steering state signal correcting means disposed between the steering state detecting means and the motor control signal generating means, and the steering state signal correcting means corrects a steering state detecting signal corresponding to an input of the motor control signal generating means in accordance with a time on the basis of the detecting signal outputted from the operation stop detecting means.

### BACKGROUND OF THE INVENTION

1. Field of the Invention

The present invention relates to an electric power steering apparatus structured such that a steering assist force generated by a motor is applied to a steering system in a motor vehicle or a vehicle, and more particularly to an electric power steering apparatus which improves a steering feeling at a time of stopping a control of a control unit.

2. Description of the Prior Art

An electric power steering apparatus applying an assisting load to a steering apparatus in a motor vehicle or a vehicle on the basis of a rotational force of a motor is structured such as to apply a driving force of a motor as an assisting load to a steering shaft or a rack shaft by a transmitting mechanism such as a gear, a belt or the like via speed reduction gears. The conventional electric power steering apparatus mentioned above executes a feedback control of a motor electric current in order to accurately generate an assist torque(a steering assist torque). The feedback control is structured such as to adjust a motor applied voltage so that a difference between a command value of an electric current and a detected value of a motor electric current is reduced, and an adjustment of the motor applied voltage is generally performed by adjusting a duty ratio of a PWM(Pulse Width Modulation) control.

In this case, a description will be given of a popular structure of the electric power steering apparatus with reference to FIG. 1.

A shaft 2 of a steering handle 1 is connected to a tie rod 6 of a steered tire wheel via speed reduction gears 3, universal joints 4a and 4b and a pinion rack mechanism 5. A torque sensor(a steering torque detecting means) 10 for detecting a steering torque of the steering handle 1 is provided in the shaft 2, and a motor 20 assisting the steering force of the steering handle 1 is connected to the shaft 2 via the speed reduction gears 3. An electric power is supplied to a control unit 30 for controlling the power steering apparatus from a battery 14 via an ignition key 11 and a relay 13, and the control unit 30 calculates a steering assist command value I of an assist command on the basis of a steering torque T detected by the torque sensor 10 and a vehicle speed V detected by the vehicle speed sensor 12, and controls the electric current supplied to the motor 20 on the basis of the calculated steering assist command value I.

The control unit 30 is mainly constituted by a CPU. A normal function executed in accordance with a program within the CPU is structured as shown in FIG. 2.

A description will be given of a function and an operation of the control unit 30. The steering torque T detected by the torque sensor 10 so as to be inputted is phase-compensated by a phase compensator 31 for the purpose of increasing a stability of the steering system, and the phase-compensated steering torque TA is inputted to a steering assist command value calculator 32. Further, the vehicle speed V detected by the vehicle speed sensor 12 is also inputted to the steering assist command value calculator 32. The steering assist command value calculator 32 determines the steering assist command value I corresponding to a control target value of an electric current supplied to the motor 20 by referring to a characteristic map(look-up table) 33 on the basis of the inputted steering torque TA and the vehicle speed V.

The steering assist command value I is inputted to a subtractor 30A, and inputted to a differential compensator 34 of a feed-forward system for increasing a speed of response, a deviation(I−i) calculated by the subtractor 30A is inputted to a proportion calculator 35, and a proportional output is inputted to an adder 30B and input to an integral calculator 36 for improving the characteristic of the feedback system. The outputs of the differential compensator 34 and the integral calculator 36 are added and inputted to the adder 30B, and a current command value E corresponding to an added result in the adder 30B is inputted to a motor drive circuit 37 so as to constitute as a motor driving signal. A motor current value “i” of the motor 20 is detected by a motor current detecting circuit 38, and the detected motor current value “i” is inputted to the subtractor 30A so as to be fed back.

The electric power steering apparatus mentioned above stops the motor control in the case of turning the ignition key 11 to an OFF-state from an ON-state, the case that a stop signal is generated from a failure diagnosing means(not shown) detecting a failure of the control unit, and the like. When the motor control is stopped in the case of turning off the ignition key 11 as mentioned above, the case that the stop signal is generated from the failure diagnosing means, and the like, the steering torque is rapidly increased and the steering handle 1 becomes rapidly heavy, so that not only a high grade feeling of the steering is deteriorated, but also a steering feeling is significantly deteriorated particularly during the steering.

In conventional, as the electric power steering apparatus solving the problem mentioned above, there are structures shown in Japanese Patent Publication No. 7-94226 B2 and Japanese Patent Publication No. 7-94227 B2.

An electric power steering apparatus described in Japanese Patent Publication No. 7-94227 B2 is provided with an operation stop detecting means for detecting an operation stop command of a motor control signal generating means, and a correcting means for gradually reducing a motor control signal together with a time on the basis of a detecting signal outputted from the operation stop detecting means. In this structure, the correcting means is provided between the motor control signal generating means and the motor driving means.

FIG. 3 shows the structure. This electric power steering apparatus is provided with a steering state detecting means 100 constituted by a steering torque detecting means 101 for detecting the steering torque of the steering system and a steering rotation detecting means 102 for detecting a number of steering rotation, a motor control signal generating means 110 for determining and outputting a motor control signal on the basis of the detecting signal outputted from the steering state detecting means 100, and a motor driving means 111 for driving the motor on the basis of the motor control signal, and the power steering apparatus is further provided with switches 112 such as a key switch and an external switch, a failure diagnosing means 113 for the apparatus, an operation stop detecting means 114 for detecting an operation stop of the apparatus itself and a correcting means 120 arranged between the motor control signal generating means 110 and the motor driving means 111 for the purpose of gradually reducing the motor control signal together with a time on the basis of detected signals outputted from the operation stop detecting means 114.

In the structure mentioned above, when the switches 112 for operating and stopping the apparatus itself are in an OFF-state or the stop signal is outputted from the failure diagnosing means 113, the operation stop detecting means 114 detects that the apparatus is operated or stopped on the basis of the signals. Then, the correcting means 120 reduces the motor control signal together with the time on the basis of the detecting signal outputted from the operation stop detecting means 114 so as to output to the motor driving means 111, thereby gently stopping the motor.

FIG. 4 shows an example of the operation. At first, a whole of the control system is initialized(Step S20), the failure diagnosing means 113 inputs the steering torque detecting signal from the steering torque detecting means 102(Step S21), and a failure diagnosis is executed(Step S22). The failure diagnosing means 113 next inputs a current detecting signal from the motor driving means 111(Step S23) and executes the same failure diagnosis(Step S24), and further the operation stop detecting means 114 inputs a detecting signal from the switches 112(Step S25). The motor control signal generating means 110 calculates the motor control signal in accordance with the steering torque detecting signal from the steering torque detecting means 101 and 102(Step S26), and corrects the calculated motor control-signal by the correcting means 120. Thereafter, the operation stop detecting means 114 judges from the switches 112 whether or not the operation stop state is established(Step S30), and when the operation state is not stopped, the motor driving means outputs the corrected motor control signal so as to drive the motor(Step S31), and is returned to the Step S21 mentioned above.

On the contrary, at the Step S30 mentioned above, in the case that it is judged by the operation stop detecting means 114 that the operation stop state is established, the correcting means 120 gradually reduces the motor control signal from the motor control signal generating means 110 in accordance with the time(Step S32), and the failure diagnosing means 113 judges whether or not the motor control signal is “0”(Step S33). If the motor control signal is not “0”, the step goes to the Step S31, and if it is “0”, the power steering apparatus(EPS) is stopped and the process is finished(Step S34).

On the contrary, an electric power steering apparatus described in Japanese Patent Publication No. 7-94226 B2 is provided with an initial state detecting means for detecting an operation start state of a motor control signal generating means, and a correcting means for gradually increasing a motor control signal until a determined value together with a time on the basis of a detecting signal outputted from the detecting means. In this structure, the correcting means is provided between the motor control signal generating means and the motor driving means.

FIG. 5 shows the structure. When a switch such as a key switch is turned on, respective detecting signals are outputted from a steering torque detecting means 131 and an initial state detecting means 132. In a motor control signal generating means 133, a motor control signal is determined and outputted on the basis of the steering torque signal outputted from the steering torque detecting means 131. In a correcting means 130, when a detecting signal showing a start state is inputted from the initial state detecting means 132, the detecting signal is corrected until the determined value of the motor control signal for the purpose of gradually increasing the motor control signal, and the motor is driven and controlled by a motor driving means 134 on the basis of the corrected motor control signal.

Although a motor control signal monitoring means is not disclosed in Japanese Patent Publication No. 7-94226 B2 and Japanese Patent Publication No. 7-94227 B2, it is necessary to detect an abnormal state of the motor control signal generating means in relation with torque detecting means and the motor driving means. When the motor control signal monitoring means is used with the above described apparatus, in the methods disclosed in the respective publications mentioned above, since the motor control signal is reduced or increased without relation to the motor control signal generating means, there is a problem that it is impossible to function the motor control signal monitoring means during reducing or increasing the motor control signal. That is, when the operation stop state or the initial state is detected, the calculated result of the motor control signal is forcibly changed so as to be reduced or increased together with the time, so that the calculated result of the motor control signal is corrected. Accordingly, a relation between the normal steering detecting signal and the current for actually driving the motor is not established, so that it is unavoidable to cancel the monitoring during the correction.

Further, in the electric power steering apparatus, it is desirable to make the steering force heavier for a comparatively long time so as not to apply a sense of discomfort to a driver at a time of turning off the key switch. On the contrary, since an abnormality exists within a system at a time of detecting the failure, it is dangerous unless the system is quickly stopped, and inversely, if the system is suddenly stopped, the handle is taken and a dangerous state is generated in the vehicle, so that it is desirable to stop the system after making the steering force heavier as fast as possible within a range that the handle is not taken. Accordingly, it is hard to solve both problems by one correcting method.

Still further, in the conventional system in which a weight of the vehicle is small, so much steering assist force is not required and an assist ratio(ratio between the steering force in the case that the electric power steering apparatus functions and the steering force after stopping) is small, it is possible to make the steering force sufficiently heavy so as not to reduce the steering feeling for a comparatively short time. However, in order to prevent the steering feeling in the system in which the weight of the vehicle is heavy and the assist ratio is large from being reduced, the effect of preventing the sense of discomfort can be obtained only by making the steering force heavier for a sufficiently long time, so that there eminently appears the problem mentioned above.

### SUMMARY OF THE INVENTION

The present invention is made by taking the matters mentioned above into consideration, and an object of the present invention is to provide an electric power steering apparatus which does not stop a function of a motor control signal monitoring means and improves a steering feeling, even in the case of stopping a motor control.

The present invention relates to an electric power steering apparatus provided with a steering state detecting means for detecting a steering state of a steering system, a motor control signal generating means for determining and outputting a motor control signal on the basis of a steering state detecting signal outputted from the steering state detecting means, a motor driving means for driving a motor on the basis of a motor control signal outputted from the motor control signal generating means, and a motor control signal monitoring means for monitoring the motor control signal generating means on the basis of the signals outputted from the steering state detecting means and the motor driving means, and the object mentioned above of the present invention can be achieved by the feature that the electric power steering apparatus is provided with an operation stop detecting means for detecting an operation stop command of the motor control signal generating means, and a steering state signal correcting means disposed between the steering state detecting means and the motor control signal generating means, and the steering state signal correcting means corrects a steering state detecting signal corresponding to an input of the motor control signal generating means in accordance with a time on the basis of the detecting signal outputted from the operation stop detecting means.

Further, the object mentioned above of the present invention can be achieved by the feature that the electric power steering apparatus is provided with a control start detecting means for detecting a control start command of the motor control signal generating means, and a steering state signal correcting means disposed between the steering state detecting means and the motor control signal generating means, and the steering state signal correcting means corrects a steering state detecting signal corresponding to an input of the motor control signal generating means in accordance with a time on the basis of the detecting signal outputted from the control start detecting means.

The present invention relates to an electric power steering apparatus provided with a steering state detecting means for detecting a steering state of a steering system, a motor control signal generating means for determining and outputting a motor control signal on the basis of a steering state detecting signal outputted from the steering state detecting means, and a motor driving means for driving a motor on the basis of a motor control signal outputted from the motor control signal generating means, and the object mentioned above of the present invention can be achieved by the feature that the electric power steering apparatus is provided with an operation stop detecting means for detecting an operation stop command of the motor control signal generating means, a plurality of steering state signal correcting means disposed between the steering state detecting means and the motor control signal generating means, and a correction method selecting means for selecting and utilizing the plurality of steering state correcting means, and the steering state signal correcting means selected by the correction method selecting means corrects a steering state detecting signal corresponding to an input of the motor control signal generating means in accordance with a time on the basis of the detecting signal outputted from the operation stop detecting means.

Further, the object mentioned above of the present invention can be more effectively achieved by the feature that the steering state signal correcting means is selected by the correction method selecting method so as to gradually increase at a time of turning on the ignition key or at a time of returning from the abnormal battery voltage, or the feature that a traveling speed detecting means for inputting a vehicle sped signal is provided in the correction method selecting means and the selection is executed by the correction method selecting means on the basis of the vehicle speed signal, or the feature that the steering state signal correcting means starts the correction on the basis of the signal outputted from the failure diagnosing means before the operation is stopped.

### BRIEF DESCRIPTION OF THE DRAWINGS

In the accompanying drawings:

FIG. 1 is a schematic view for explaining a general electric power steering apparatus;

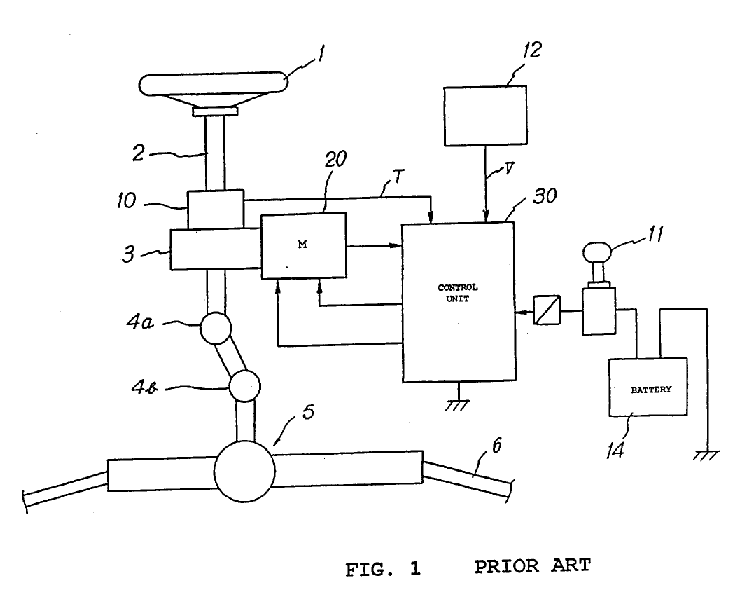

FIG. 2 is a block diagram showing an example of a structure of a control unit;

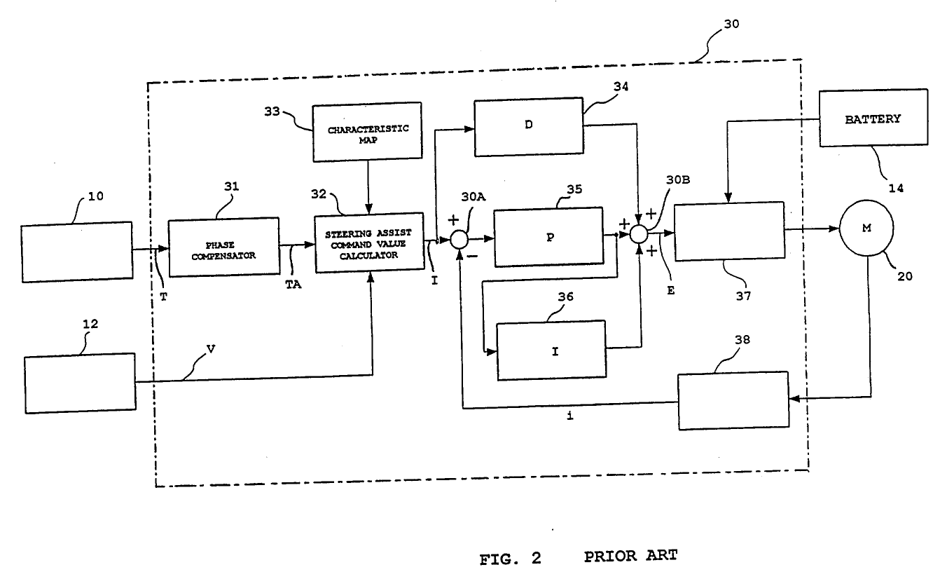

FIG. 3 is a block diagram showing an example of a conventional apparatus;

FIG. 4 is a flow chart showing an example of an operation in accordance with the conventional apparatus;

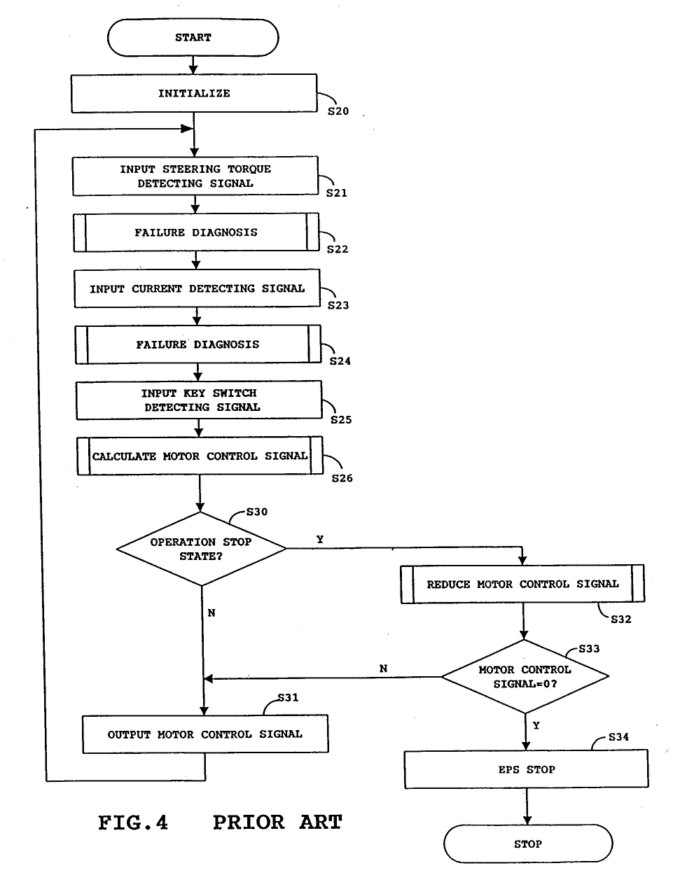

FIG. 5 is a block diagram showing an example of a conventional apparatus;

FIG. 6 is a block diagram showing a structure of a first embodiment in accordance with the present invention;

FIG. 7 is a flow chart showing an example of an operation in accordance with the present invention;

FIG. 8 is a schematic view showing an embodiment of a correcting means in accordance with the present invention;

FIG. 9 is a schematic view showing another embodiment of a correcting means in accordance with the present invention;

FIG. 10 is a block diagram showing a structure of a second embodiment in accordance with the present invention;

FIG. 11 is a block diagram showing a structure of a third embodiment in accordance with the present invention;

FIG. 12 is a flow chart showing an example of an operation of the third embodiment in accordance with the present invention;

FIG. 13 is a block diagram showing a structure of a forth embodiment in accordance with the present invention;

FIG. 14 is a flow chart showing an example of an operation of the forth embodiment in accordance with the present invention;

FIG. 15 is a view for explaining the operation of the forth embodiment in accordance with the present invention;

FIG. 16 is a block diagram showing a structure of a fifth embodiment in accordance with the present invention;

FIG. 17 is a view showing an example of a characteristic of a correcting means used in the fifth embodiment and a sixth embodiment;

FIG. 18 is a block diagram showing a structure of a sixth embodiment in accordance with the present invention;

FIG. 19 is a block diagram showing a structure of a seventh embodiment in accordance with the present invention; and

FIG. 20 is a block diagram showing a structure of a eighth embodiment in accordance with the present invention.

### DESCRIPTION OF THE PREFERRED EMBODIMENTS

In accordance with the present invention, the steering state signal correcting means(steering torque input correcting means) is provided between the steering state detecting means (steering torque detecting means) and the motor control signal generating means so as to reduce the steering state detecting signal(steering torque signal) inputted to the motor control signal generating means, thereby correcting the steering state detecting signal corresponding to a motor current command in accordance with a time as a result of calculation executed by the motor control signal generating means while keeping a function of the motor control signal generating means. The steering state detecting signal is corrected after detecting the operation stop state, and the motor control signal is calculated by using the corrected steering state detecting signal.

Further, the electric power steering apparatus is provided with a control start detecting means for detecting a control start command of the motor control signal generating means, thereby increasing the steering state detecting signal in accordance with a time on the basis of the detecting signal.

Still further, in accordance with the present invention, a plurality of steering state signal correcting means(steering torque input correcting means) having different characteristics are provided between the steering state detecting means(steering torque detecting means) and the motor control signal generating means so as to select the steering state signal correcting means(the steering torque input correcting means) by the correction method selecting means and reduce the steering state detecting signal(steering torque signal) inputted to the motor control signal generating means by the selected steering state signal correcting means(the steering torque input correcting means), thereby correcting the steering state detecting signal corresponding to a motor current command in accordance with a time as a result of calculation executed by the motor control signal generating means while keeping a function of the motor control signal generating means. The steering state detecting signal is corrected after detecting the operation stop state, and the motor control signal is calculated by using the corrected steering state detecting signal.

Therefore, in accordance with the present invention, since the monitoring mechanism is assembled in a rear stage of the steering state detecting signal after being corrected, it is possible to monitor during the correction of the steering state detecting signal.

A description will be in detail given below of embodiments in accordance with the present invention with reference to the accompanying drawings.

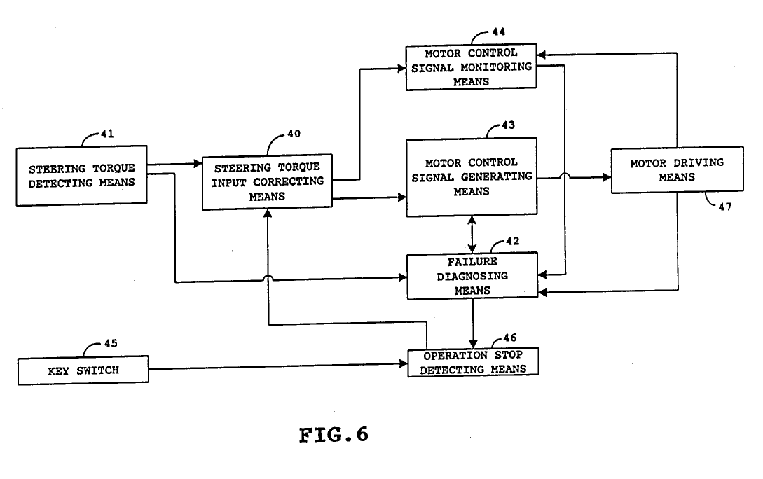

FIG. 6 is a block diagram showing a first embodiment in accordance with the present invention. The structure is made such that a monitoring function is obtained even when an assist is reduced. A steering torque detecting signal outputted from a steering torque detecting means 41 constituting a steering state detecting means is inputted to a steering torque input correcting means 40 and a failure diagnosing means 42, and a corrected signal of the steering torque detecting signal which is corrected by the steering torque input correcting means 40 is inputted to a motor control signal generating means 43 and a motor control signal monitoring means 44. Further, an output of a key switch 45 is inputted to an operation stop detecting means 46, and a motor driving means 47 drives and controls a motor in accordance with the motor control signal outputted from the motor control signal generating means 43. The failure diagnosing means 42 monitors whether or not a failure exists in the steering torque detecting means 41, the motor control signal monitoring means 44 and the motor driving means 47, and a result of diagnosis in the failure diagnosing means 42 is inputted to the operation stop detecting means 46 and the motor control signal generating means 43. The operation stop detecting means 46 is structured such as to detect an OFF-operation applied by the key switch 45, and detects an operation stop command of the motor control signal generating means 43.

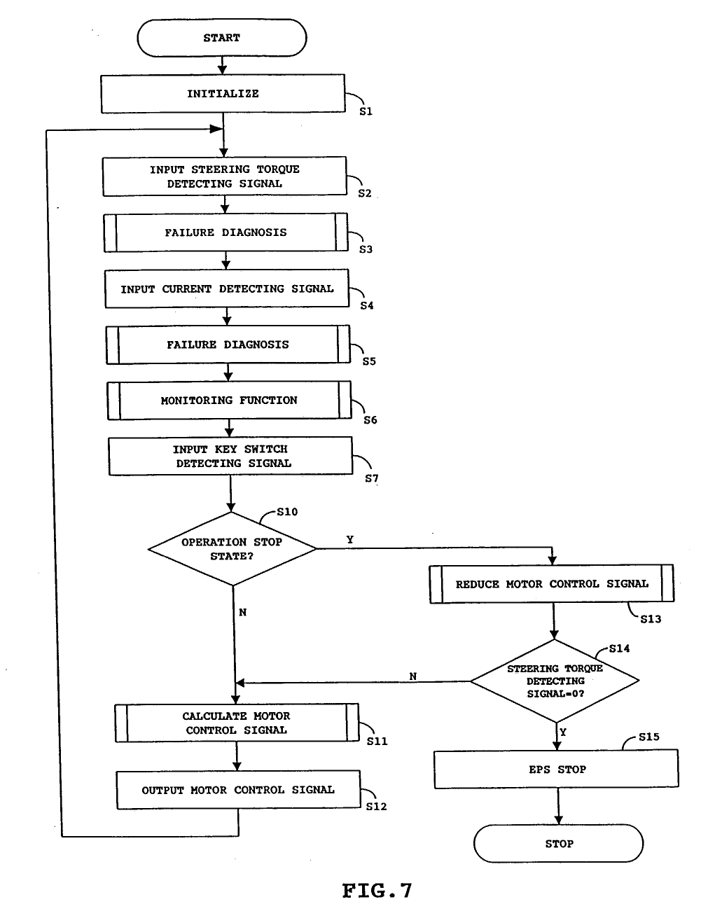

In the structure mentioned above, a description will be given of an operation thereof with reference to a flow chart shown in FIG. 7.

At first, a whole of a control system is initialized(Step S1), and the failure diagnosing means 42 inputs a steering torque detecting signal from a steering torque detecting means 41(Step S2), and executes a failure diagnosis(Step S3). The failure diagnosing means 42 next inputs a current detecting signal from the motor driving means 47(Step S4) and executes the same failure diagnosis(Step S5), the motor control signal monitoring means 44 executes a monitoring function(Step S6), and the operation stop detecting means 46 inputs a detecting signal outputted from the key switch 35(Step S7) and judges whether or not it is an operation stop state(Step S10). If the operation state is not stopped, the motor control signal generating means 43 executes a calculation of the motor control signal in accordance with the steering torque detecting signal outputted from the steering torque detecting means 41 via the steering torque input correcting means 40(Step S11) and outputs the motor control signal(Step S12), whereby the motor is driven and controlled via the motor driving means 47. Together with this operation, the step is returned to the Step S2 mentioned above.

On the contrary, in the Step S10 mentioned above, in the case that it is judged by the operation stop detecting means 46 that it is the operation stop state, the steering torque detecting signal outputted from the steering torque detecting means 41 is gradually reduced in accordance with a time in the steering torque input correcting means 40(Step S13), and the motor control signal monitoring means 44 judges whether or not the steering torque correcting signal is “0”(Step S14). If the steering torque correcting signal is not “0”, the step goes to the Step S11 mentioned above, and if it is “0”, the power steering apparatus(EPS) is stopped and the process is finished(Step S15).

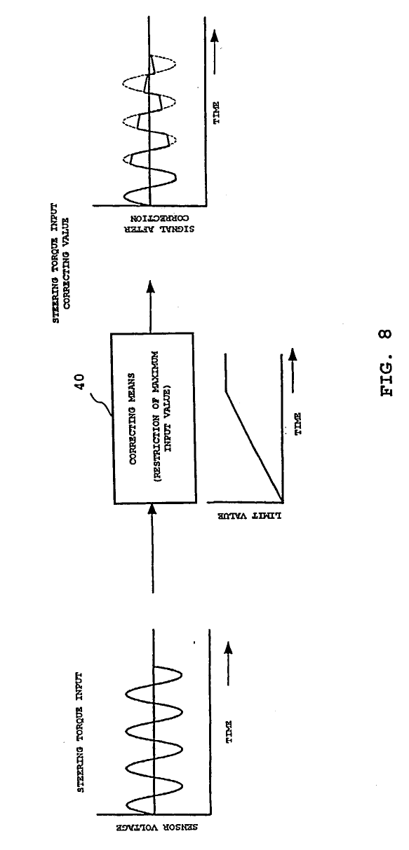

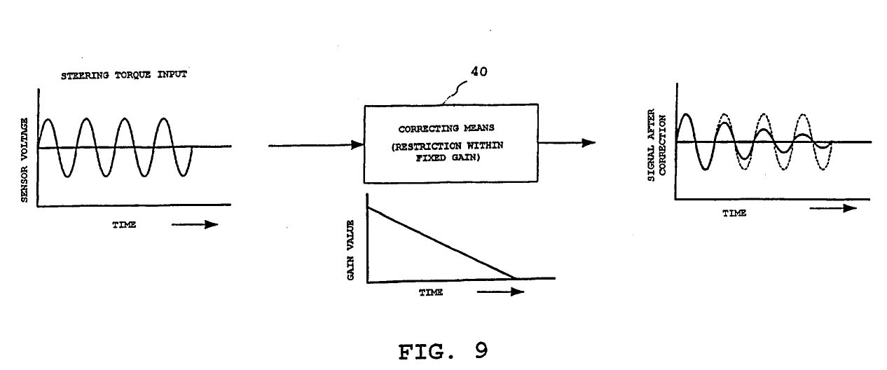

FIG. 8 shows an embodiment of the steering torque input correcting means 40. This steering torque input correcting means 40 is structured such as to limit the maximum input value with respect to the steering torque input, and is characterized in that it is possible to securely reduce to a target value for a short time. Further, FIG. 9 shows another embodiment. It is possible to limit within a fixed gain with respect to the steering torque input. In this case, it is characterized in that it is possible to smoothly reduce without sense of discomfort.

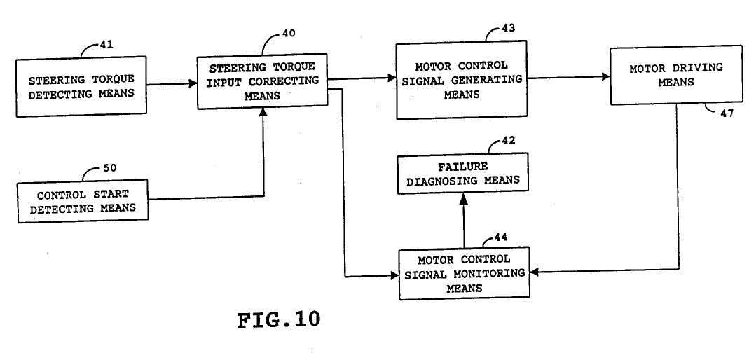

FIG. 10 shows a second embodiment in accordance with the present invention in correspondence to FIG. 6. In this embodiment, the structure is made such that a monitoring function is provided even when an assist is increased. That is, a control start detecting means 50 for detecting a control start command of the motor control signal generating means 43 is provided, and a detecting signal thereof is inputted to the steering torque input correcting means 40. Then, the steering torque input correcting means 40 gradually increases the steering torque detecting signal corresponding to the input of the motor control signal generating means 43 in accordance with a time on the basis of the detecting signal outputted from the control start detecting means 50. The steering torque in the steering torque input correcting means 40 is monitored by the motor control signal monitoring means 44, and when the steering torque detecting signal becomes a predetermined value, the failure diagnosing means 42 detects the failure.

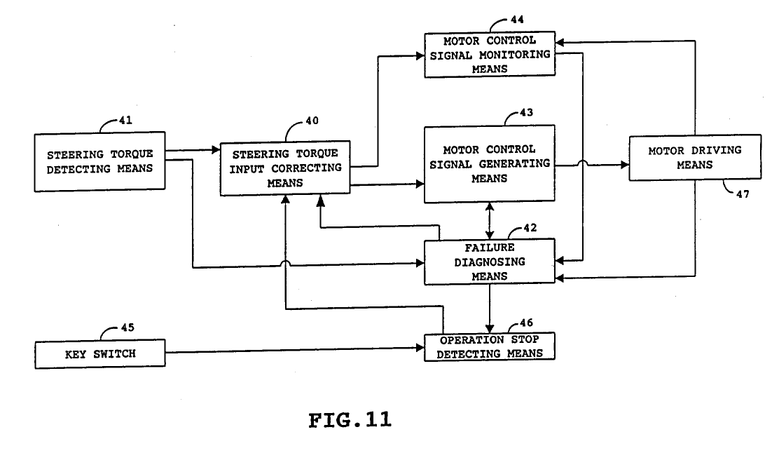

Further, FIG. 11 shows a third embodiment in accordance with the present invention in correspondence to FIG. 6. In this embodiment, the structure is made such that a correction can be started before stopping the operation. This embodiment is different from the first embodiment mentioned above in view that the result of diagnosis of the failure diagnosing means 42 is inputted to the steering torque input correcting means 40.

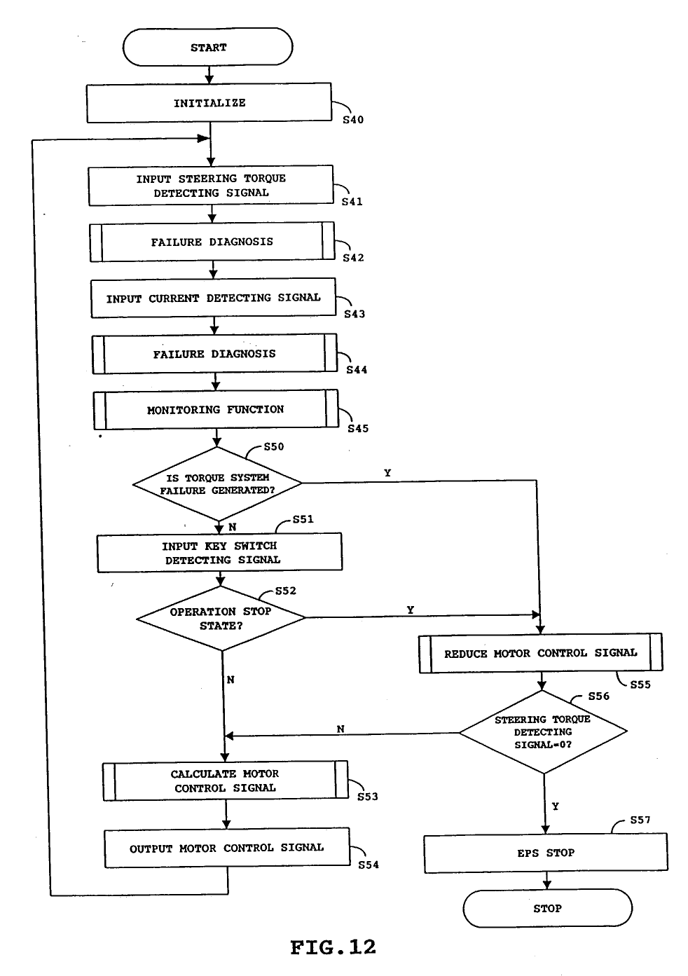

A description will be given of an operation of the third embodiment with reference to a flow chart shown in FIG. 12.

At first, a whole of a control system is initialized(Step S40), and the failure diagnosing means 42 inputs a steering torque detecting signal from a steering torque detecting means 41(Step S41), and executes a failure diagnosis(Step S42). The failure diagnosing means 42 next inputs a current detecting signal from the motor driving means 47(Step S43) and executes the same failure diagnosis(Step S44), and the motor control signal monitoring means 44 executes a monitoring function(Step S45). The failure diagnosing means 42 judges whether or not a failure in a torque system is generated(Step S50), and in the case that the failure in the torque system is not generated, the operation stop detecting means 46 inputs a detecting signal outputted from the key switch 45(Step S51) and judges whether or not it is an operation stop state(Step S52). If the operation state is not stopped, the motor control signal generating means 43 executes a calculation of the motor control signal in accordance with the steering torque detecting signal outputted from the steering torque detecting means 41 via the steering torque input correcting means 40(Step S53) and outputs the motor control signal(Step S54), whereby the motor is driven and controlled via the motor driving means 47. Together with this operation, the step is returned to the Step S41 mentioned above.

On the contrary, in the case that it is judged in the Step S50 mentioned above that the failure in the torque system is generated and in the case that in the Step S52 mentioned above, in the case that it is judged by the operation stop detecting means 46 that it is the operation stop state, the steering torque detecting signal outputted from the steering torque detecting means 41 is gradually reduced in accordance with a time in the steering torque input correcting means 40(Step S55), and the motor control signal monitoring means 44 judges whether or not the steering torque correcting signal is “0”(Step S56). If the steering torque correcting signal is not “0”, the step goes to the Step S53 mentioned above, and if it is “0”, the power steering apparatus(EPS) is stopped and the process is finished(Step S57).

In each of the embodiments mentioned above, the steering torque detecting means is listed up as the steering state detecting means and the description is given of the correction executed by the steering torque input correcting means corresponding to the correcting means, however, the structure may be made such that the steering state detecting means is constructed by adding a steering rotation detecting means and a steering state signal correcting means is constituted by including the steering torque.

In accordance with the above embodiments according to the present invention, the steering state correcting means is provided between the steering state detecting means and the motor control signal generating means so as to reduce or increase the steering state detecting signal inputted to the motor control signal generating means, thereby reducing or increasing the signal corresponding to the motor current command in accordance with the time as the result of calculation executed by the motor control signal generating means itself while keeping the function of the motor control signal generating means. The motor control signal is calculated by reducing or increasing the steering state detecting signal after detecting the operation stop state or the control start state and using the reduced or increased steering state detecting signal. As mentioned above, since the monitoring mechanism is assembled in the rear stage of the steering state detecting signal after being corrected, it is possible to monitor during the correction.

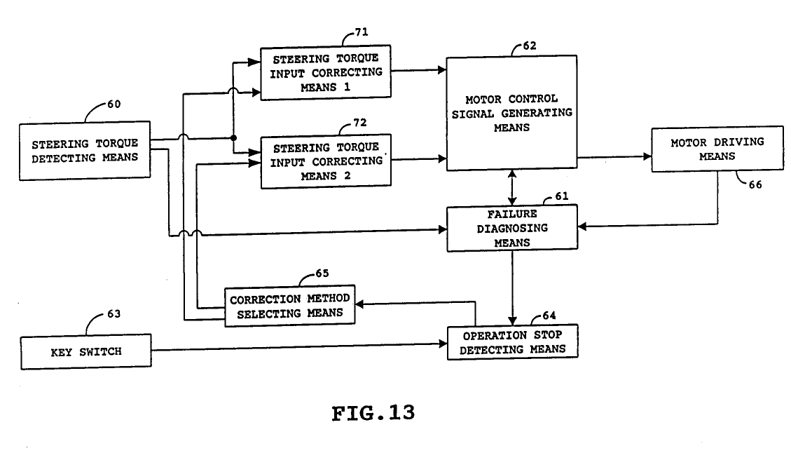

FIG. 13 is a block diagram showing a first embodiment in accordance with the present invention. A steering torque detecting signal outputted from a steering torque detecting means 60 constituting a steering state detecting means is inputted to two steering torque input correcting means 71 and 72 having different characteristics and a failure diagnosing means 61, and each of corrected signals of the steering torque detecting signals which are corrected by the steering torque input correcting means 71 and 72 is inputted to a motor control signal generating means 62. Further, an output of a key switch 63 is inputted to an operation stop detecting means 64, and a motor driving means 66 drives and controls a motor in accordance with the motor control signal outputted from the motor control signal generating means 62. Two steering torque input correcting means 71 and 72 are selected by a correction method selecting means 65, and the correction method selecting means 65 is controlled by the detecting signal of the operation stop detecting means 64. The failure diagnosing means 61 diagnoses whether or not a failure exists in the steering torque detecting means 60, the motor control signal generating means 62 and the motor driving means 66, and a result of diagnosis in the failure diagnosing means 61 is inputted to the operation stop detecting means 64 and the motor control signal generating means 62. The operation stop detecting means 64 detects an OFF-operation applied by the key switch 63.

In accordance with the present invention, a plurality of steering correcting means(the steering torque input correcting means 71 and 72) are arranged between the steering state detecting means(the steering torque detecting means 60) and the motor control signal generating means 62, and the correction method selecting means 65 for selecting an optimum correcting means for the system on the basis of the detecting signal outputted from the operation stop detecting means 64 is provided, thereby reducing the steering torque detecting signal inputted to the motor control signal generating means 62 in accordance with the state of the system.

As a condition for switching the correcting means 71 and 72, there are (1) a normal system stopping time due to turning off of the ignition key, (2) a system stopping time corresponding to a fail safe due to a trouble of the steering torque input system, and the like.

Since the case of the item (1) mentioned above is a frequently executed normal sequences it is possible to gently make the steering force heavier mainly in view of applying no sense of discomfort to the driver. At this time, since there is a possibility that the driver executes the steering, it generates a motion different from an intention of the driver if the steering force is simply made heavier in one direction, thereby rather applying the sense of discomfort. Accordingly, it is necessary to make the steering force heavy while reflecting the intention of the driver, so that it is desirable to continue to input the latest torque while making the steering force heavy so as to make the steering force heavy on the basis of the input value. Further, since the case of the item (2) is a sequence which is not generated in a normal case, and the system is already abnormal, it is a main object to safely stop the system, and it is necessary to understand that applying no sense of discomfort to the driver is an additional function, so that it is necessary to make the steering force heavy and finish the system for a time as short as possible within a range capable of allowing the sense of discomfort. Further, since the torque detecting input corresponding to a base for calculating the assist force(the motor control signal) is already the abnormal value and can not be used, it is desirable to execute a process for safely stopping such as setting the input value before the fail is generated to a fixed input, or the like.

Further, in the case of switching the input in addition to the calculation contents of the correction, as the correcting means for switching in the manner mentioned above, it is effective to execute the correction between the steering state detecting means(the steering torque detecting means 60) and the motor control signal generating means 42 as shown in FIG. 13. Because, in accordance with the structure of the present invention, elements required for switching and correction are all completed between the steering state detecting means(the steering torque detecting means 60) and the motor control signal generating means 62 and the structure after the motor control signal generating means 62 corresponding to a core of the electric power steering apparatus is the same, so that it is possible to put the correction and switching into practice by a simple structure without taking into consideration an influence after the motor control signal generating means 62.

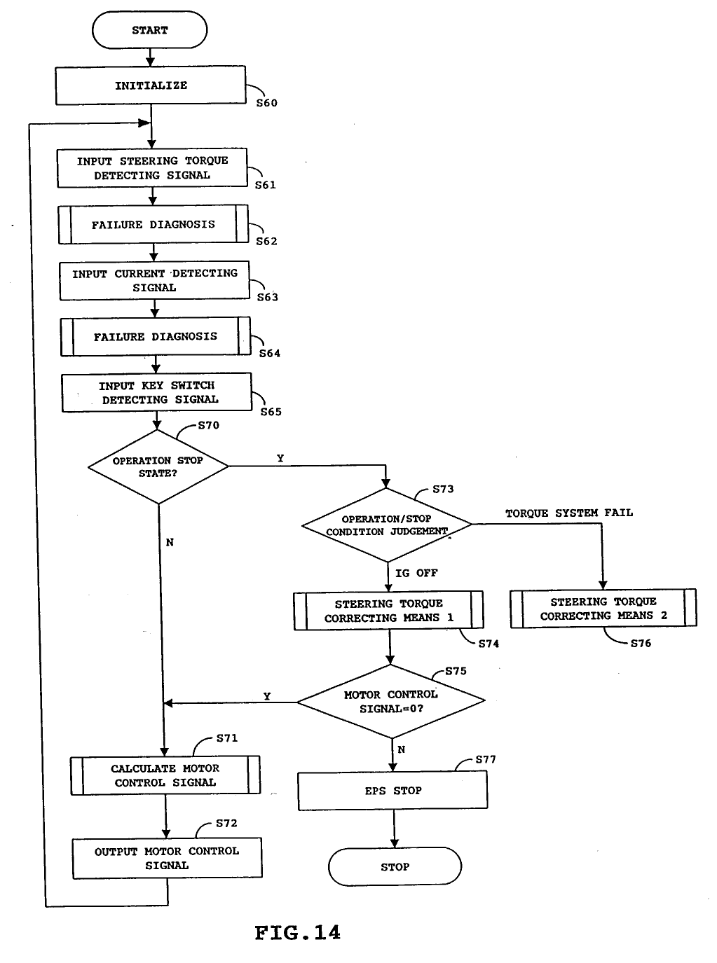

In the structure shown in FIG. 13, a description will be given of an operation thereof with reference to a flow chart shown in FIG. 14.

At first, a whole of a control system is initialized(Step S60), and the failure diagnosing means 61 inputs a steering torque detecting signal from a steering torque detecting means 60(Step S61), and executes a failure diagnosis(Step S62). The failure diagnosing means 61 next inputs a current detecting signal from the motor driving means 66(Step S63) and executes the same failure diagnosis(Step S64), and the operation stop detecting means 64 inputs a detecting signal outputted from the key switch 63(Step S65) and judges whether or not it is an operation stop state(Step S70). If the operation state is not stopped, the motor control signal generating means 62 executes a calculation of the motor control signal in accordance with the steering torque detecting signal outputted from the steering torque detecting means 60 via the steering torque input correcting means 71 or 72(Step S71) and outputs the motor control signal(Step S72), whereby the motor is driven and controlled via the motor driving means 66. Together with this operation, the step is returned to the Step S61 mentioned above.

On the contrary, in the Step S70 mentioned above, in the case that it is judged by the operation stop detecting means 64 that it is the operation stop state, an operation stop condition is judged(Step S73). That is, if the ignition key is in an OFF-state, the steering torque input correcting means 71 is selected via the correction method selecting means 65(Step S74), and if the torque system fail exists, the steering torque input correcting means 72 is selected via the correction method selecting means 65(Step S76). The steering torque detecting signal outputted from the steering torque detecting means 60 is gradually reduced in accordance with a time in the steering torque input correcting means 71 or 72, and next it is judged whether or not the steering torque detecting signal is “0”(Step S75). If the steering torque detecting signal is not “0”, the step goes to the Step S71 mentioned above, and if it is “0”, the power steering apparatus(EPS) is stopped and the process is finished(Step S77).

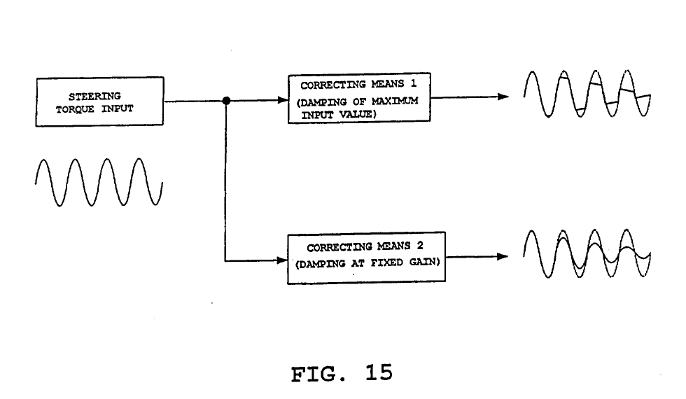

FIG. 15 shows a relation between the steering torque detecting signal outputted from the steering torque detecting means and a damping property of the steering torque input correcting means 71 and 72. The steering torque input correcting means 71 is structured such as to damp the maximum input value, and the steering torque input correcting means 72 is structured such as to damp a fixed gain. In the case that the correction method selecting means 65 judges the correction due to the off operation of the ignition key, the normal torque input is used as the input of the motor control signal generating means 62, the damping at the fixed gain is executed as the correction calculation in the steering torque input correcting means 72, and a sufficiently long time is given to the correction time. Further, in the case that the correction method selecting means 65 judges the correction due to the failure detection of the torque system, the torque input value before the fail is used as the input of the motor control signal generating means 62, the damping of the maximum input value is executed as the correction calculation in the steering torque input correcting means 71, and the correction is finished for a short time.

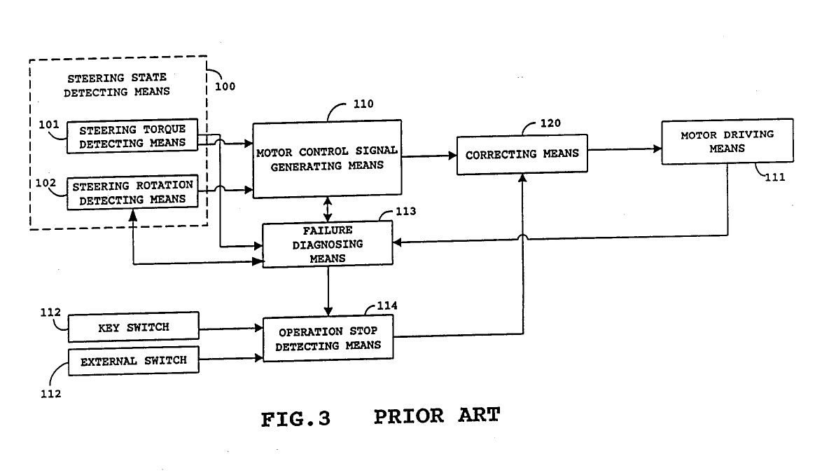

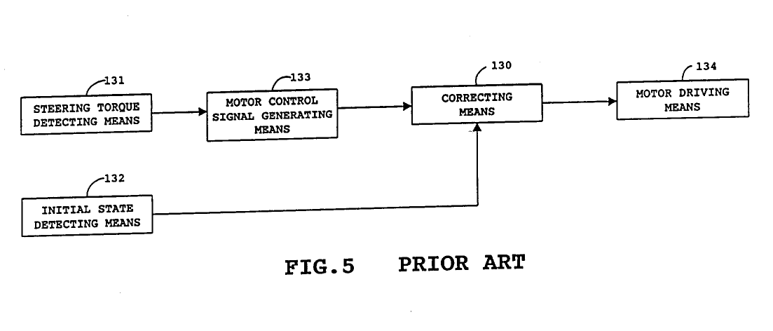

In this case, it is possible to obtain the same effect by adding a plurality of correcting means and the correction method selecting means to the structure such as the conventional embodiment(FIGS. 3 and 5), however, it is necessary to take into consideration the influence of the motor control signal generating means for the purpose of putting the correction and switching into practice, so that the structure becomes very complex and it is hard to put into practice.

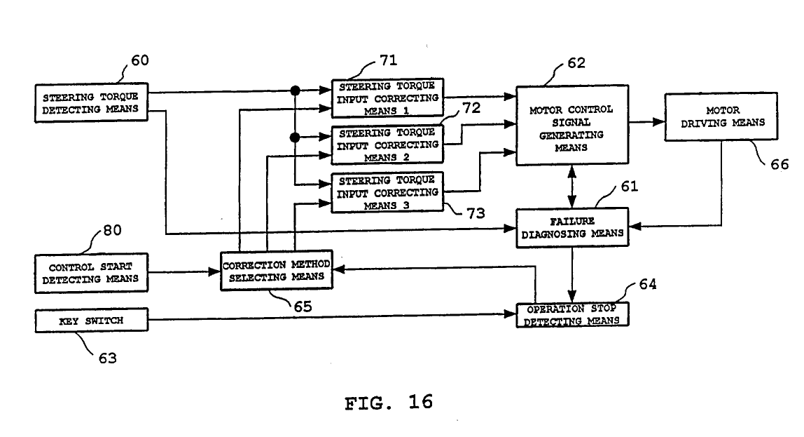

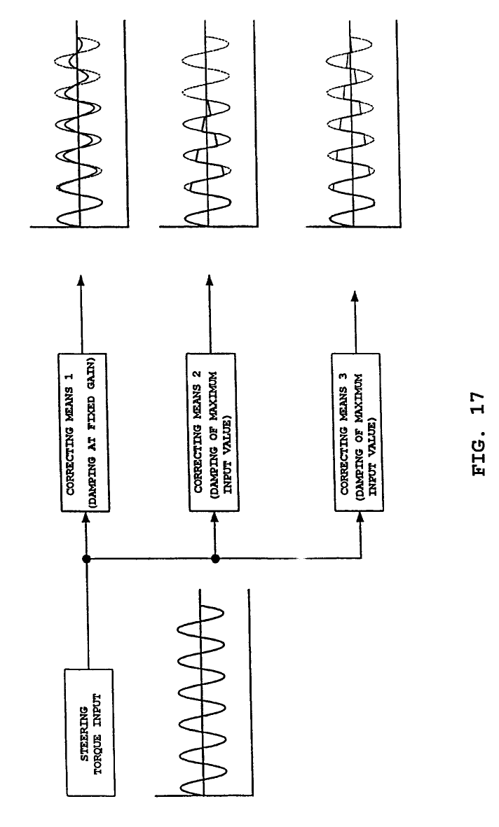

FIG. 16 shows a fifth embodiment in accordance with the present invention in correspondence to FIG. 13. In this embodiment, the structure is made such that three systems of steering torque input correcting means 71 to 73 including the assist increasing time are provided, thereby controlling the correction method selecting means 65 on the basis of the detecting signal of the control start detecting means 80. That is, the control start detecting means 80 for detecting a control start command of the motor control signal generating means 62 is provided, and a detecting signal thereof is inputted to the correction method selecting means 65. Then, the steering torque input correcting means 71 to 73 are selected on the basis of the selecting signal outputted from the correction method selecting means 65 so as to gradually increase the steering torque detecting signal corresponding to the input of the motor control signal generating means 62 in accordance with a time. Conditions for switching are an on operation of the ignition key, a fail of the torque system, and an abnormality of a voltage in the battery. The characteristics of the steering torque input correcting means 71 and 73 are structured as shown in FIG. 17, the correcting means 71 executes a correction in accordance with a damping at a fixed gain, the correcting means 72 executes a correction in accordance with a damping at a maximum input value, and the correcting means 73 executes a correction in accordance with a damping at a maximum input value.

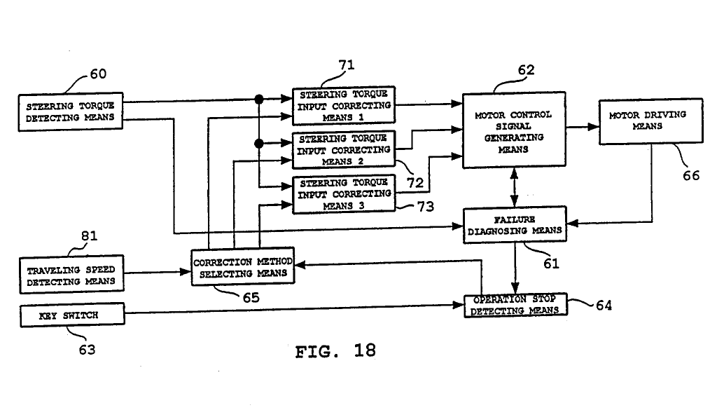

Further, FIG. 18 shows a sixth embodiment in accordance with the present invention in correspondence to FIG. 13. In this embodiment, the structure is made such that a traveling speed detecting means 81 is provided as a condition of the correcting method. A vehicle speed signal detected by the traveling speed detecting means 81 is inputted to the correction method selecting means 65. As an input for switching the correction method, an OFF-operation of the ignition key, a fail(a vehicle speed low) of the torque system and a fail(a vehicle speed high) of the torque system are employed. In this case, the steering torque input correcting means 71 to 73 are structured such as to respectively correct in accordance with the characteristics shown in FIG. 17.

In the structure mentioned above, in the case that the correction method selecting means 65 judges that it is the correction in accordance with the OFF-operation of the ignition key via the operation stop detecting means 64, the normal torque input is used as the input of the motor control signal generating means 62, the damping at the fixed gain is executed as the correction calculation in the steering torque input correcting means 71 and a sufficiently long time(some seconds to some tens seconds) is given to the correcting time. Further, in the case that it is judged to be the correction in accordance with the failure detection of the torque system and the vehicle speed is low, the torque input value before the fail is used as the input of the motor control signal generating means 62, the damping of the maximum input value is executed as the correction calculation in the steering torque input correcting means 73, and the correction is finished for a comparatively short time(about 10 to 100 milli-seconds). Further, in the case that it is judged to be the correction in accordance with the failure detection of the torque system and the vehicle speed is high, the torque input value before the fail is used as the input of the motor control signal generating means 62, the damping of the maximum input value is executed as the correction calculation in the steering torque input correcting means 72, and the correction is finished for a shorter time than the above(about 1 to 10 milli-seconds).

In the sixth embodiment, when the vehicle speed is high, a motion of the vehicle with respect to the handle input is great and there is a low possibility that a large input is given as the handle input, so that the third embodiment is effective in the case that it is intended to early stop the assist. When the correction is executed for a long time, the vehicle moves in an unintended direction. When the vehicle speed is low, the motion of the vehicle with respect to the handle input is small and there is a high possibility that a large input is given as the handle input, so that it is possible to achieve the correcting effect.

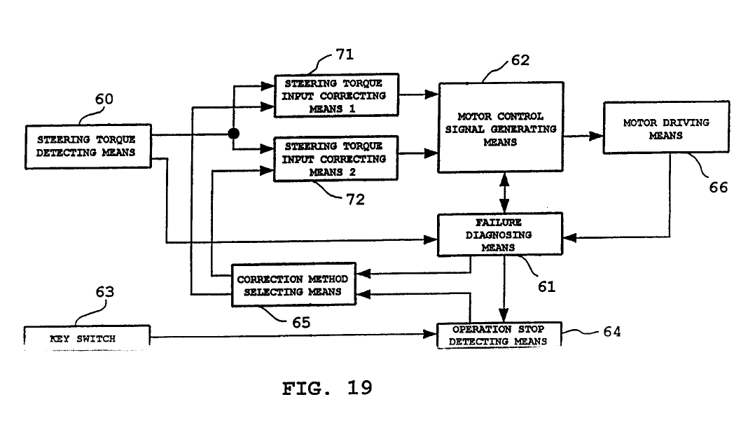

FIG. 19 shows a seventh embodiment in accordance with the present invention in correspondence to FIG. 13. In this embodiment, the structure is made such that the correction can be started before the operation is stopped. This embodiment is different from the forth embodiment in view that the result of diagnosis of the failure diagnosing means 61 is inputted to the correction method selecting means 65.

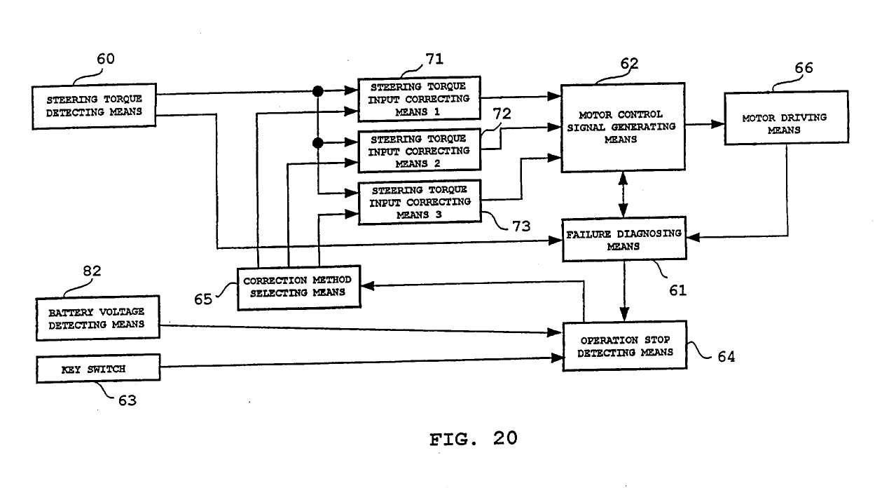

In this case, as the condition of switching and inputting the correction method, it is possible to consider the OFF-operation of the ignition key, the fail of the torque system, the reduction of the battery voltage and the increase of the battery voltage. The structure of the eighth embodiment in this case is shown in FIG. 20.

In the case that the correction method selecting means 65 judges that it is the correction in accordance with the OFF-operation of the ignition key, the normal torque input is used as the input of the motor control signal generating means 62, the damping at the fixed gain is executed as the correction calculation and a sufficiently long time is given to the correcting time in the steering torque input correcting means 71. In the case that it is judged to be the correction in accordance with the failure detection of the torque system, the torque input value before the fail is used as the input of the motor control signal generating means 62, the damping of the maximum input value is executed as the correction calculation in the steering torque input correcting means 72, and the correction is finished for a short time. Further, in the case that the battery voltage is reduced, it is detected by the battery voltage detecting means 82, the selection of the correcting means is executed by the correction method selecting means 65 via the operation stop detecting means 64, the normal torque input is used as the input of the motor control signal generating means 62, the damping at the fixed gain is executed as the correction calculation, and the correcting time in the steering torque input correcting means 73 is set to a sufficiently long time. In the case that the battery voltage is increased, in the same manner, it is detected by the battery voltage detecting means 82, the torque input value before the fail is used as the input of the motor control signal generating means 62, the damping at the fixed gain is executed as the correction calculation, and the correction in the steering torque input correcting means 72 is finished for a short time.

In accordance with the eighth embodiment, in the case that the battery voltage is reduced, since it is not the normal sequence but corresponds to a comparatively easily generated phenomenon, it is possible to gently make the steering force heavier with mainly paying attention only to the matter giving no sense of discomfort to the driver, and in the case that the battery voltage is increased, there is a risk that the system is damaged due to an abnormal increase which is not generated in the normal using state, however, it is possible to prevent the system breakage mentioned above.

In each of the embodiments mentioned above, the steering torque detecting means is listed up as the steering state detecting means and the description is given of the correction executed by the steering torque input correcting means corresponding to the correcting means, however, the structure may be made such that the steering state detecting means is constructed by adding a steering rotation detecting means and a steering state signal correcting means is constituted by including the steering torque.

In accordance with the forth to eighth embodiments, a plurality of steering state correcting means are provided between the steering state detecting means and the motor control signal generating means so as to reduce or increase the steering state detecting signal inputted to the motor control signal generating means, thereby reducing or increasing the signal corresponding to the motor current command in accordance with the time as the result of calculation executed by the motor control signal generating means itself while keeping the function of the motor control signal generating means. The motor control signal is calculated by reducing or increasing the steering state detecting signal after detecting the operation stop state or the control start state and using the reduced or increased steering state detecting signal. Since the steering state correcting means is selected in an optimum manner in correspondence to the state of the system, it is possible to improve the steering feeling.

Executing the correction on the basis of the motor control signal in accordance with the conventional embodiment corresponds to outputting without respect to the control system, so that the operation during the correction becomes unstable. In particular, in the case that the assist ratio is large(a weight of the vehicle is heavy and a difference between a state with an assist and a state without an assist is large), the effect can be obtained only when the correcting time is set to a long time, so that the control system diverges if the output without respect to the control system is continued during the period, and a danger may be generated because there is a possibility that it is oscillated. In accordance with the present invention, since it is possible to correct while keeping the control block except the torque system by correcting the torque system, it is possible to put a stable correction into practice.

The present invention can be, of course, applied to a column type and a pinion type electric power steering apparatus, and further, can be also applied to a rack assist type electric power steering apparatus.

What is claimed is:

1. An electric power steering apparatus comprising:
a steering state detecting means for detecting a steering state of a steering system;
a motor control signal generating means for determining and outputting a motor control signal on the basis of a steering state detecting signal outputted from the steering state detecting means;
a motor driving means for driving a motor on the basis of a motor control signal outputted from the motor control signal generating means; and
a motor control signal monitoring means for monitoring the motor control signal generating means on the basis of the signals outputted from the steering state detecting means and the motor driving means,
wherein said electric power steering apparatus is further provided with an operation stop detecting means for detecting an operation stop command of said motor control signal generating means, and a steering state signal correcting means disposed between said steering state detecting means and said motor control signal generating means, and said steering state signal correcting means corrects a steering state detecting signal corresponding to an input of said motor control signal generating means in accordance with a time on the basis of the detecting signal outputted from said operation stop detecting means.

2. An electric power steering apparatus as claimed in claim 1, wherein at a time of reducing the steering state detecting signal, a maximum input limiting value of an input value of the steering state detecting signal is restricted in accordance with a passage of time.

3. An electric power steering apparatus as claimed in claim 1, wherein at a time of reducing the steering state detecting signal, a gain of an input value of the steering state detecting signal is restricted in accordance with a passage of time.

4. An electric power steering apparatus as claimed in claim 1, wherein said steering state signal correcting means can start correction on the basis of the signal outputted from a failure diagnosing means before stopping the operation.

5. An electric power steering apparatus as claimed in claim 1, wherein said steering state signal correcting means can correct the steering state detecting signal on the basis of the value of just before the damage when a torque signal system has become the damage.

6. An electric power steering apparatus as claimed in claim 4, wherein said failure diagnosing means detects a presence/absence of a failure of said motor control signal monitoring means and said motor driving means.

7. An electric power steering apparatus comprising:
a steering state detecting means for detecting a steering state of a steering system;
a motor control signal generating means for determining and outputting a motor control signal on the basis of a steering state detecting signal outputted from said steering state detecting means;
a motor driving means for driving a motor on the basis of a motor control signal outputted from said motor control signal generating means; and
a motor control signal monitoring means for monitoring said motor control signal generating means on the basis of the signals outputted from said steering state detecting means and said motor driving means,
wherein said-electric power steering apparatus is further provided with a control start detecting means for detecting a control start command of said motor control signal generating means, and a steering state signal correcting means disposed between said steering state detecting means and said motor control signal generating means, and said steering state signal correcting means increases a steering state detecting signal corresponding to an input of said motor control signal generating means in accordance with a time on the basis of the detecting signal outputted from said control start detecting means.

8. An electric power steering apparatus as claimed in claim 7, wherein at a time of increasing the steering state detecting signal, a maximum input limiting value of an input value of the steering state detecting signal is increased in accordance with a passage of time.

9. An electric power steering apparatus as claimed in claim 7, wherein at a time of increasing the steering state detecting signal, a gain of an input value of the steering state detecting signal is increased in accordance with a passage of time.

10. An electric power steering apparatus as claimed in claim 7, wherein a failure diagnosing means is provided to detect a presence/absence of a failure of said motor control signal monitoring means and said motor driving means, a diagnosing result is inputted to said steering state signal correcting means.

11. An electric power steering apparatus comprising:
a steering state detecting means for detecting a steering state of a steering system;
a motor control signal generating means for determining and outputting a motor control signal on the basis of a steering state detecting signal outputted from said steering state detecting means; and
a motor driving means for driving a motor on the basis of a motor control signal outputted from said motor control signal generating means;
wherein said electric power steering apparatus is further provided with an operation stop detecting means for detecting an operation stop command of said motor control signal generating means, a plurality of steering state-signal correcting means disposed between said steering state detecting means and said motor control signal generating means, and a correction method selecting means for selecting and utilizing said plurality of steering state signal correcting means and said steering state signal correcting means selected by said correction method selecting means corrects a steering state detecting signal corresponding to an input of said motor control signal generating means in accordance with a time on the basis of the detecting signal outputted from said operation stop detecting means.

12. An electric power steering apparatus as claimed in claim 11, wherein said steering state signal correcting means is selected by the correction method selecting method so as to gradually increase at a time of turning on the ignition key or at a time of returning from the abnormal battery voltage.

13. An electric power steering apparatus as claimed in claim 11, wherein a traveling speed detecting means for inputting a vehicle sped signal to said correction method selecting means is provided, and the selection is executed by said correction method selecting means on the basis of the vehicle speed signal.

14. An electric power steering apparatus as claimed in claim 11, wherein a control start detecting means for inputting a control start signal to said correction method selecting means is provided, and the selection is executed by said correction method selecting means on the basis of the control start signal.

15. An electric power steering apparatus as claimed in claim 11, wherein said steering state signal correcting means starts the correction on the basis of the signal outputted from the failure diagnosing means before the operation is stopped.
